(19) United States
(12) Patent Application Publication
(10) Pub. No.: US 2011/0196764 A1
(43) Pub. Date: Aug. 11, 2011

(54) System and method for virtually staging property

(76) Inventors: James T. Bell, JR., Atlanta, GA (US); Krisztina M. Bell, Atlanta, GA (US)

(21) Appl. No.: 12/658,387

(22) Filed: Feb. 5, 2010

(51) Int. Cl. G06Q 30/00; G06K 9/03; G06Q 20/00; G06Q 90/00; G06F 17/30; G06F 15/16; G06Q 50/00

(52) U.S. Cl. 705/27.2; 382/311; 705/40; 705/500; 709/204; 709/218; 709/217; 707/783

(57) ABSTRACT

A system for virtually staging property to market real estate including a computing device communicably linked to a computer network, a database accessible by the computing device containing a plurality of images of household items, and software executing on the computing device for receiving a digital photograph of a room of the property from a user via the computer network, retrieving at least one of the plurality of images from the database, digitally editing the retrieved image into the received digital photograph, and transmitting the edited digital photograph to the user via the computer network.

### CROSS-REFERENCE TO RELATED APPLICATIONS

This applications claims the benefit of U.S. Provisional Patent Application Ser. No. ______ filed Feb. 6, 2009, which is hereby incorporated by reference.

### BACKGROUND OF THE INVENTION

In a competitive real estate market, photographs of a home viewed online are often the first impressions a potential buyer gets when viewing numerous properties for sale on real estate listing-based websites. However, many pictures of vacant homes look very similar with neutral walls and sometimes unidentifiable rooms. Therefore, motivated sellers want the pictures of the property they are selling to be instantly recognizable by potential buyers online and be remembered because of their warm and inviting appearance.

Traditionally, properties for sale have been physically staged by actually decorating the home with furnishings and other home décor to improve the perceptions and impressions of potential buyers when they view the home. However, the staging process is often expensive, time-consuming, and/or labor intensive.

### SUMMARY OF THE INVENTION

Therefore, it is an object of the present invention to provide a cost-effective real estate marketing solution for a fraction of the cost of traditional staging by virtually staging the property by adding images of real furnishings to the actual photographs of the property, thus transforming the photographs into attractive, attention-getting pictures that drive buyer traffic to the home for sale.

To attain the above object, according to an aspect of the invention, there is provided a system for virtually staging property to market real estate including a computing device communicably linked to a computer network, a database accessible by the computing device containing a plurality of images of household items, software executing on the computing device for receiving a digital photograph of a room of the property from a user via the computer network, retrieving at least one of the plurality of images from the database, digitally editing the retrieved image into the received digital photograph, and transmitting the edited digital photograph to the user via the computer network.

Preferably, the system further includes software executing on the computing device for operating and maintaining a website accessible by the user via the computer network, and the user uploads the digital photograph of the room to the computer via the website.

The computer network preferably includes the Internet, and the user preferably includes a seller offering at least one property for sale or lease.

Preferably, the images of household items in the database include images of furnishings and household décor.

The system preferably further includes software executing on the computing device for permitting access to the database to the user, and enabling the user to selectively edit the received digital photograph using at least one image from the database.

Preferably, the system further includes software executing on the computing device for permitting access to the database to the user, and enabling the user to download at least one image from the database.

The system preferably further includes software executing on the computing device for facilitating a payment from the user for the edited digital photograph.

In another aspect of the present invention, there is provided a method for marketing a property including obtaining a digital photograph of a room of the property to be staged, digitally editing the photograph to add at least one image of a household item, and presenting the edited photograph to potential buyers.

Preferably, the edited photograph is presented to potential buyers on an information flyer.

The edited photograph is preferably presented to potential buyers on an online listing service.

These and other exemplary features and advantages of the present invention will become clear from the following description with reference to the accompanying drawings.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 shows a schematic of an exemplary embodiment of the present invention.

FIG. 2 shows an exemplary photograph of a dining room before being virtually staged.

FIG. 3 shows the photograph of FIG. 2 after being virtually staged.

FIG. 4 shows an exemplary photograph of a living room before being virtually staged.

FIG. 5 shows the photograph of FIG. 4 after being virtually staged.

FIG. 6 shows an exemplary photograph of a bedroom before being virtually staged.

FIG. 7 shows the photograph of FIG. 6 after being virtually staged.

### DETAILED DESCRIPTION OF THE INVENTION

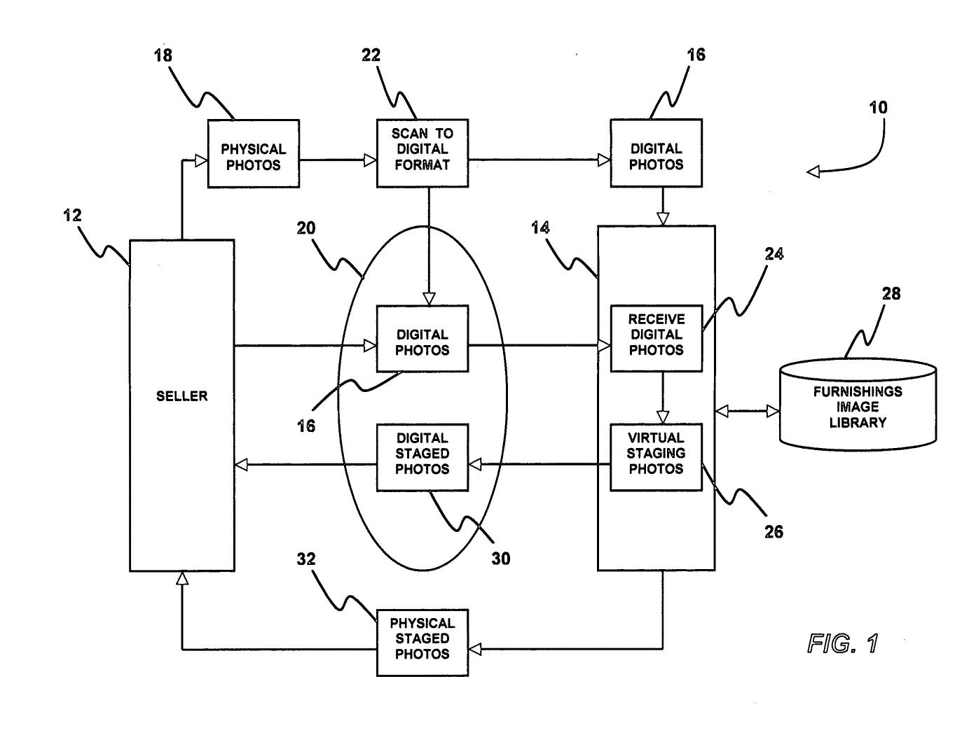

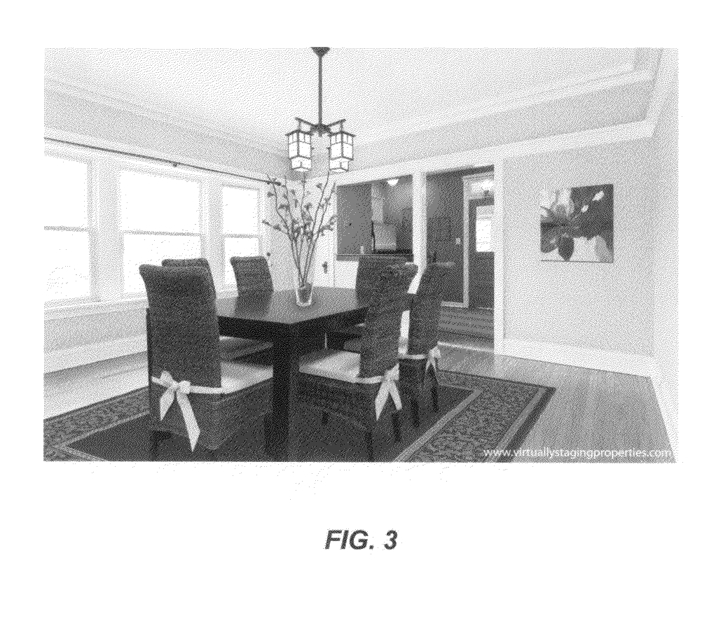

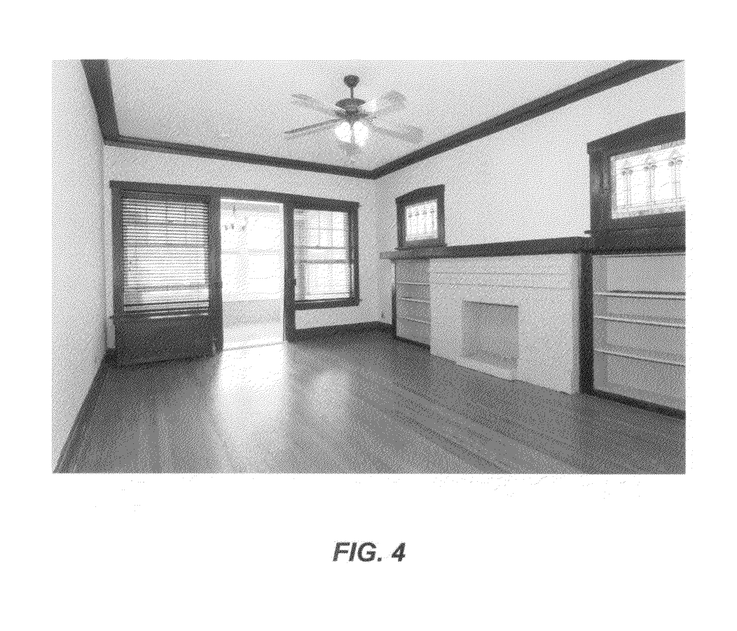

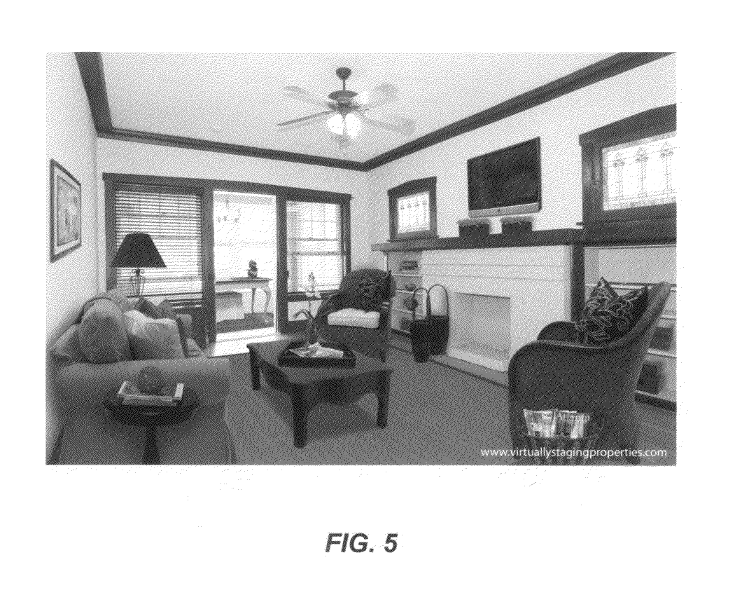

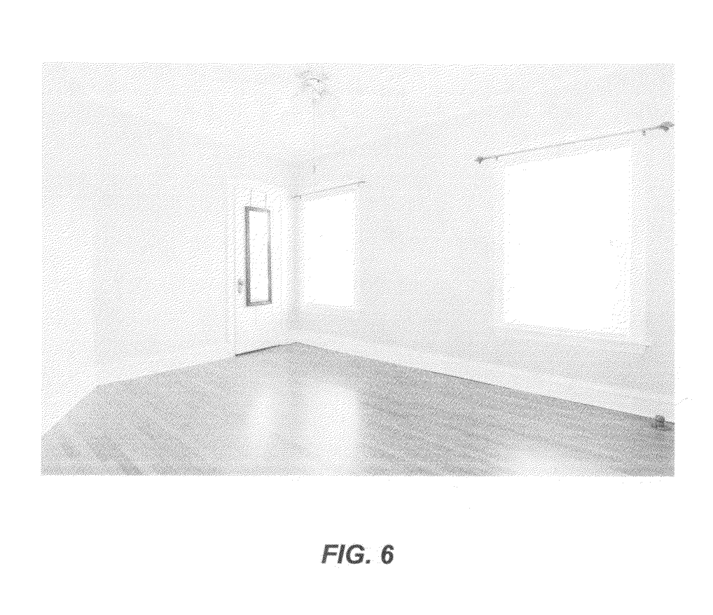

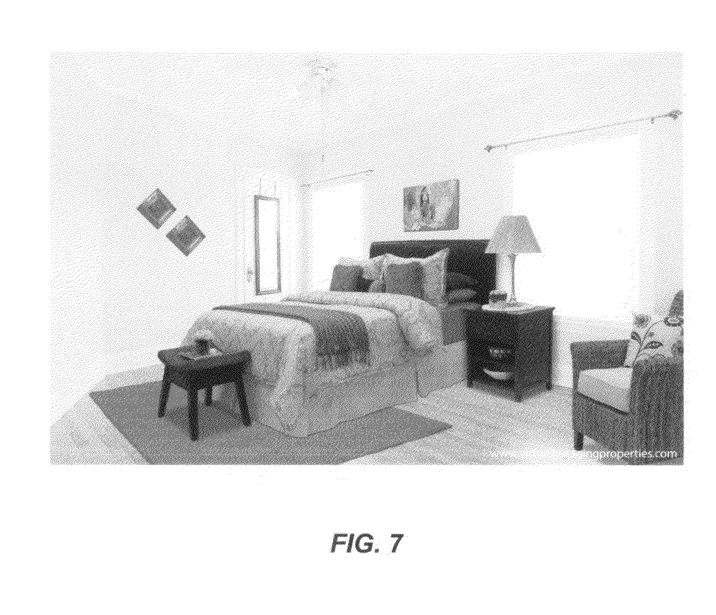

Referring now to the drawings, and more particularly to FIGS. 1-7, there are shown exemplary embodiments of the system according to the present invention.

FIG. 1 shows a schematic of an exemplary embodiment of the virtual staging system 10 of the present invention. Initially, the seller 12 provides photographs 16,18 of various rooms of the home for sale to the virtual staging entity 14 to be virtually staged.

Preferably, digital photographs 16 are electronically transmitted from the seller 12 to the virtual staging entity 14 over a computer network 20, such as the Internet. The digital photographs 16 provided to the virtual staging entity 14 may be in any suitable format such as, for example, Joint Photographic Experts Group (JPEG), Tagged Image File Format (TIFF), or Encapsulated PostScript (EPS).

The digital photographs 16 are preferably uploaded to the virtual staging entity 14 via a dedicated website operated by the virtual staging entity 14. However, it should be understood that the transmission of the digital photographs 16 may be accomplished through other known electronic means, such as electronic mail service or other file transfer protocol (FTP) procedures. It should also be understood that one or more physical data storage devices, such as optical discs or a flash memory data storage devices, containing the digital photographs 16 may be physically provided to the virtual staging entity 14, such as by hand, mail or delivery service.

Physical photographs 18 of the home for sale may be scanned and converted into a suitable digital format 22 using appropriate scanning equipment and software. The seller 12 may scan and convert 22 the physical photographs 18 prior to providing the digital photographs 16 to the virtual staging entity 14. However, the seller 12 may alternately provide the physical photographs to the virtual staging entity 14 for subsequent scanning and converting 22 by the virtual staging entity 14.

The photographs 16,18 may be shot by anyone affiliated with or hired by a party of interest in the sale of the home, for example, the seller 12, the agent, or the virtual staging entity 14. Preferably, the photographs 16,18 include pictures of the living room, dining room, kitchen, master bedroom and master bathroom. However, the seller 12 may provide photographs of any room, and as many rooms, of the property for sale that they may wish to have virtually staged by the virtual staging entity 14.

Preferably, the property is vacant when photographed in order to expedite and facilitate the virtual staging process. However, it should be understood that the photographs may be edited to remove existing furnishings that appear in the photographs, if necessary. Additionally, the photographs 16,18 are preferably taken in proper lighting levels, avoid under/over-exposure, and utilize natural or ambient light to further facilitate the virtual staging process.

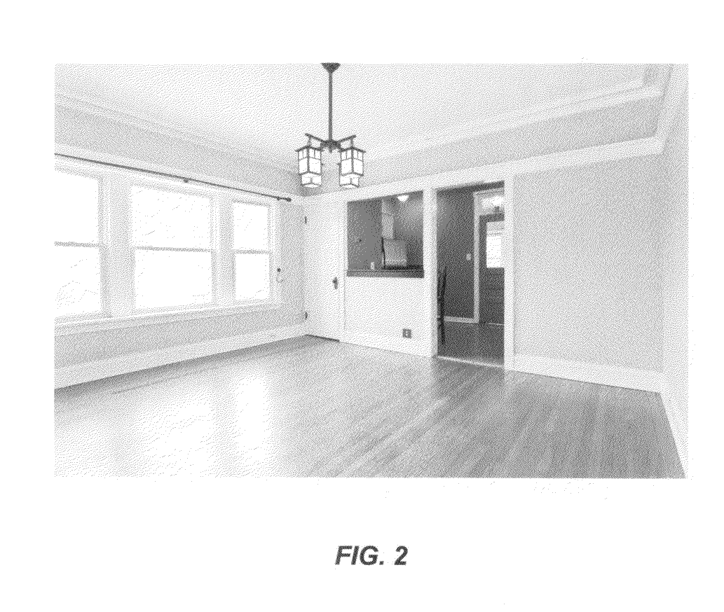

Upon receipt of suitable digital photographs 24, the virtual staging entity 14 uses editing software to virtually stage 26 the rooms by overlaying images of furniture, decorations and other pieces on to the received digital photographs 16. Suitable furnishings and décor are selectively added to the photographs depending on the type of room and stylistic notions of the virtual staging entity 14. In this manner, a photograph of a vacant room can be transformed into a picture of an attractive well-appointed room that would be pleasing to potential buyers of the home. FIGS. 2-7 show exemplary before and after illustrations of staged photographs.

The images added to the photographs are pulled from a furnishings image library 28. The library 28 comprises an electronic database containing an inventory of digital images of a wide selection and variety of furniture, decorations and other pieces organized by style, size and viewing angle. It is to be understood that the database may be organized in any manner desired by the virtual staging entity 14.

Once the photographs have been virtually staged 26, they are returned to the seller 12 for use in marketing materials. Preferably, the staged digital photographs 30 are electronically transmitted to the seller 12 over the computer network 20. For example, the transmission may be accomplished through a dedicated website, electronic mail service, or file transfer protocol (FTP) procedure. However, it should be understood that physical copies of the staged photographs 32 or one or more physical data storage devices, such as optical discs or flash memory data storage devices, containing the staged digital photographs 30 may be physically provided to seller 12, such as by hand, mail or delivery service.

The seller 12 may then utilize the staged photographs 30,32 in the marketing materials for the home for sale. For example, the staged photographs 30,32 may be used in informational flyers and online listings. In the event the staged photographs 30 are used as part of the property's online real estate listings, the staged photographs 30 may positively differentiate the property from other listings. In this manner, the staged photographs 30 may increase traffic both on the website and in the actual home and, therefore, increase the selling opportunities for the seller 12 of the home.

Printed enlargements of the staged photographs 30,32 may also be physically posted at the property that was virtually staged in the photographs. Posting such staged photographs 30,32 would be particularly helpful when the property for sale is vacant, in order to help potential buyers better visualize what a particular room could look like when decorated while actually visiting the property.

Preferably, the furnishings image library 28 is created by photographing the furniture, decoration and pieces to be used in virtual staging process from many different angles. The images are then suitably cataloged in a database for rapid location and retrieval when needed during the virtual staging process. Preferably, the library 28 is continuously updated and expanded to account for prevailing stylistic trends and to simply increase the options available to the virtual staging entity 14. In this manner, a large library may be created to suit a wide range of tastes and styles, and give the virtual staging entity 14 a broad range of décor options when virtually staging the photographs of the property.

The virtual staging entity 14 may also provide access to the furnishings image library 28 directly to the seller 12. In this manner, the seller 12 may virtually stage their digital photographs 16 themselves. Preferably, the seller 12 would upload a digital photograph to a dedicated website operated by the virtual staging entity 14 that permits the seller 12 to access the furnishings image library 28 and virtually stage the photograph according to the seller's preferences and selections. Alternately, the virtual staging entity 14 may permit the seller 12 to download images from the furnishings image library 28 to their personal computer to stage the photographs themselves.

Preferably, the system 10 includes a web-based application, such as a dedicated website, wherein the entire transaction between the virtual staging entity 14 and seller 12 is completed electronically. The system 10 would comprise software executing on a computer operated by the virtual staging entity 14 for hosting and maintaining the web-based application and making it accessible to the seller 12 over the Internet. The computer may be any computing device, alone or in combination, such as a personal computer, web server, mainframe, or any other computing device that is communicably linked to a computer network 20, such as the Internet. The communications link to the computer network 20 may take the form of any of the currently available means for connecting to the Internet.

The seller 12 may access the web-based application maintained by the virtual staging entity 14 over the Internet using any currently available web-browsing technology. Such browsing technology may include web-browsing software executing on any Internet-capable computing device, such as a personal computer or a handheld device. It is understood that there are many means for accessing the Internet known to those of skill in the art.

The virtual staging process of the present invention may also be implemented as a cohesive system or method of doing business in which the virtual staging entity 14 is solicited and financially compensated for creating and providing staged photographs of a property by the seller 12.

An exemplary application of the virtual staging process of the present invention would be to market furnishings to customers. In particular, furniture manufacturers and retailers could enable a potential customer to visualize how the products they sell would actually look in the customer's home by virtually staging a photograph of a room in the customer's home with the manufacturer's or retailer's products.

For example, a manufacturer or retailer may build a furnishing image library 28 containing images of the products they offer for sale. An image of a retailer's couch may then be retrieved from the library 28 and virtually added 26 to a photograph of a potential customer's living room. The virtual staging process may be accomplished online at the manufacturer's or retailer's website. Alternately, the virtual staging process may be provided directly by retailer or manufacturer or at a self-service kiosk at retail locations.

While the invention has been described with respect to the sale of homes, it should be understood that the invention can be practiced and applied to any real property transaction. For example, the invention can be applied to rental markets to allow landlords and lessors to virtually stage photographs of rental properties to better market the property to potential tenants. The invention can also be utilized to offer virtual staging of commercial properties, such as offices, conference centers, or warehouses, and retail properties, such as retail stores and malls, to show potential buyers or tenants how a property could appear or be utilized.

While the invention has been described in terms of several exemplary embodiments, those skilled in the art will recognize that the invention can be practiced with modification within the spirit and scope of the appended claims.

Further, it is noted that, Applicant's intent is to encompass equivalents of all claim elements, even if amended later during prosecution.

1. A system for virtually staging a property comprising:
a computing device communicably linked to a computer network;
a database accessible by said computing device containing a plurality of images of household items, wherein each said image of each said household item being created by photographing each said household item from a plurality of angles; and
software executing on said computing device for receiving a digital photograph of a room of the property from a user via said computer network, retrieving at least one of said plurality of images from said database, digitally editing said retrieved at least one image into said received digital photograph, and transmitting said edited digital photograph to the user via said computer network.

2. The system of claim 1 further comprising software executing on said computing device for operating and maintaining a website accessible by the user via said computer network.

3. The system of claim 2 wherein the user uploads said digital photograph of the room to said computer via said website.

4. The system of claim 1 wherein said computer network comprises the Internet.

5. The system of claim 1 wherein the user comprises a seller offering at least one property for sale or lease.

6. The system of claim 1 wherein said household items comprise furnishings and household décor.

7. The system of claim 1 further comprising software executing on said computing device for permitting access to said database to the user, and enabling the user to selectively edit said received digital photograph using at least one image from said database.

8. The system of claim 1 further comprising software executing on said computing device for permitting access to said database to the user, and enabling the user to download at least one image from said database.

9. The system of claim 1 further comprising software executing on said computing device for facilitating a payment from the user for said edited digital photograph.

10. A system for virtually staging a property comprising:
means for receiving a digital photograph of a room of the property from a user via a computer network;
means for retrieving at least one of said plurality of images from a database containing a plurality of images of household items, wherein each said image of each said household item being created by photographing each said household item from a plurality of angles;
means for digitally editing said retrieved at least one image into said received digital photograph; and
means for transmitting said edited digital photograph to the user via said computer network.

11. The system of claim 10 further comprising:
means for permitting access to said database to the user; and
means for enabling the user to selectively edit said received digital photograph using at least one image from said database.

12. The system of claim 10 further comprising:
means for permitting access to said database to the user; and
means for enabling the user to download at least one image from said database.

13. The system of claim 10 further comprising means for facilitating a payment from the user for said edited digital photograph.

14. A method for marketing a property comprising:
obtaining a digital photograph of a room of the property to be staged;
digitally editing said photograph to add at least one image of a household item, wherein each said image of each said household item being created by photographing each said household item from a plurality of angles; and
presenting said edited photograph to potential buyers.

15. The method of claim 14 wherein said edited photograph is presented to potential buyers on an information flyer.

16. The method of claim 14 wherein said edited photograph is presented to potential buyers on an online listing service.
